(19) United States
(12) Patent Application Publication
(10) Pub. No.: US 2019/0077931 A1
(43) Pub. Date: Mar. 14, 2019

(54) COMPOSITION FOR FORMING TRANSPARENT CONDUCTIVE FILM, AND TRANSPARENT CONDUCTIVE SUBSTRATE

(71) Applicant: Maxell Holdings, Ltd., Otokuni-gun, Kyoto (JP)

(72) Inventors: Takuo MIZUTANI, Otokuni-gun, Kyoto (JP); Fumie MITSUHASHI, Otokuni-gun, Kyoto (JP); Kenichiro YOSHIDA, Otokuni-gun, Kyoto (JP)

(73) Assignee: Maxell Holdings, Ltd., Otokuni-gun, Kyoto (JP)

(21) Appl. No.: 16/083,444

(22) PCT Filed: Mar. 8, 2017
(86) PCT No.: PCT/JP2017/009327

§ 371 Date: Sep. 7, 2018

(30) Foreign Application Priority Data
Mar. 30, 2016 (JP) 2016-069122

(51) Int. Cl. C08J 5/18; C08K 3/22; C09D 5/24; H01B 1/22

(52) U.S. Cl. CPC C08J 5/18; C08K 3/22; C09D 5/24; H01B 1/22; C08J 2367/00; C08K 2003/2296; C08K 2201/001; C08J 2333/08; C08K 2003/2231

(57) ABSTRACT

A composition for forming a transparent conductive film contains transparent conductive particles, a binder resin, and a solvent, in which the composition for a transparent conductive film has a solid concentration of 20 to 50 mass %, the solvent includes a solvent A having a relative evaporation rate of 1 or more and a solvent B having a relative evaporation rate of less than 1, where an evaporation rate of butyl acetate is 1, a mass ratio between the solvent A and the solvent B is solvent A: solvent B=40:60 to 5:95, and the solvent A and the solvent B each contain at least a ketone-based solvent.

### TECHNICAL FIELD

The present invention relates to a composition for forming a transparent conductive film, and a transparent conductive substrate formed using this composition.

### BACKGROUND ART

Conventionally, transparent conductive films have been manufactured by accumulating a transparent conductive metal oxide such as tin-containing indium oxide on a base material through a so-called dry process such as sputtering or vapor deposition, for example. Because the manufacturing of transparent conductive films using such a dry process method is performed under vacuum conditions, an expensive manufacturing apparatus is required, and the production efficiency is poor and is not suitable for mass production. Thus, studies have been conducted on a wet process for applying a dispersion composition containing transparent conductive particles and forming a transparent conductive film as an alternative to the above-described dry process method.

Among transparent conductive particles, tin-containing indium oxide (ITO) particles in which indium oxide contains tin have high translucency for visible light and high conductivity, and thus have been used as a material that is suitable for CRT screens and LCD screens for which antistatic and electromagnetic wave shielding are required.

Also, a coating-type transparent conductive film formed by applying, onto a base material, a dispersion composition containing transparent conductive particles of tin oxide, antimony-containing tin oxide, zinc oxide, or fluorine-containing tin oxide has been practically used, in addition to tin-containing indium oxide that has been used in a dry process method for producing a transparent conductive film.

Patent Document 1 proposes hydrocarbons, aromatic compounds, ketones, alcohols, glycols, glycol esters, glycol ethers, and the like as solvents used in a coating-type transparent conductive film. Also, Patent Document 1 proposes a coating-type transparent conductive sheet in which the ratio of the residual solvent amount in a dry coating film to the thickness of a dry film is defined, the surface electric resistance value has a small rate of change, and the haze value is low, and a method for manufacturing the same, as a method for manufacturing a coating-type transparent conductive sheet provided with a coating-type transparent conductive film.

Patent Document 2 proposes a composition for a transparent conductive sheet with excellent transparency, in which a solvent to be used in a coating-type transparent conductive film is limited to at least one selected from ketones and esters, the composition for the transparent conductive sheet having a low initial surface electric resistance value by setting a solvent A: a solvent B to 95:5 to 70:30 in weight ratio where the solvent A has a relative evaporation rate of 1 or more and the solvent B has a relative evaporation rate of less than 1, when an evaporation rate of butyl acetate is 1, so as to satisfy limited drying conditions, and the composition for the transparent conductive sheet is capable of suppressing an increase in the above-described surface electric resistance value over time, and a method for manufacturing a transparent conductive sheet using this composition.

### PRIOR ART DOCUMENTS

### Patent Document

[Patent Document 1] JP 2012-190713A

[Patent Document 2] JP 2016-207607A

### DISCLOSURE OF INVENTION

### Problem to be Solved by the Invention

However, often, in a coating composition containing transparent conductive particles, a binder resin, and a solvent, the stability of the composition was insufficient in a solvent system (MEK/toluene) disclosed in working examples of Patent Document 1, and the viscosity of the coating composition sometimes increases when stored for a long time. Also, if a transparent conductive sheet is formed using such a composition, there has been a problem in that the stability of the surface electric resistance value is insufficient, and the surface electric resistance value increases over time.

Also, with a method in which a composition for a transparent conductive sheet that is manufactured using the above-described solvent composition disclosed in Patent Document 2 and has a predetermined solid concentration was applied to a base material using a shear force using an application method that employed a gravure coater, a bar coater, or a die coater, a coating film is sufficiently leveled from the start of a material preheating period during which solvents do not rapidly evaporate to the initial stage of a constant rate drying period, and thereafter full-scale drying is performed, the above-described effect can be obtained, but with a method in which a composition having a predetermined solid concentration is sprayed in the form of mist onto a base material without applying a shear force, as with a spray coater application method, the solvents will rapidly evaporate in a spray stage, there has been the risk that the surface roughness and the haze value will increase due to a failure in leveling caused by an increase in the solid concentration, and the surface electric resistance value will increase due to a filling failure of conductive particles resulting from the amount of time to drying and solidification being small. Also, as with a spin coater application method, with a method in which droplets of the composition having a predetermined solid concentration are dripped onto a base material that is rotating at a high speed, and a shear force is applied thereto in the horizontal direction using a centrifugal force, the solvents rapidly evaporate due to high-speed rotation of the base material, and there is the risk that the surface roughness and the haze value will increase due to a failure in spreading of the composition and a failure in leveling that are caused by an increase in the solid concentration, and the surface electric resistance value will increase due to a failure in filling with conductive particles resulting from the amount of time to drying and solidification being small.

The coating compositions prepared using conventional techniques have insufficient storage stability and have unstable surface electric resistance values, and there is the risk that the surface roughness, the haze value, and the surface electric resistance value of a transparent conductive film obtained using an application method with which it is difficult to sufficiently level the composition will not be satisfactory.

The present invention provides a composition for forming a transparent conductive film that has excellent storage stability, is capable of reducing the surface roughness and the haze value of a transparent conductive film formed on a transparent substrate, and capable of sufficiently reducing the surface electric resistance value, regardless of the application method.

### Means for Solving Problem

A composition for forming a transparent conductive film according to the present invention is a composition for forming a transparent conductive film containing transparent conductive particles, a binder resin, and a solvent, in which the composition for a transparent conductive film has a solid concentration of 20 to 50 mass %, the solvent includes a solvent A having a relative evaporation rate of 1 or more and a solvent B having a relative evaporation rate of less than 1, where the evaporation rate of butyl acetate is 1, and a mass ratio between the solvent A and the solvent B is solvent A:solvent B=40:60 to 5:95, and the solvent A and the solvent B each contain at least a ketone-based solvent.

Also, a transparent conductive substrate according to the present invention is a transparent conductive substrate including a transparent substrate and a transparent conductive film disposed on the transparent substrate, in which the transparent conductive film is formed using the above-described composition for forming a transparent conductive film of the present invention.

### Effects of the Invention

According to the present invention, it is possible to provide a composition for forming a transparent conductive film that has excellent storage stability, is capable of reducing the surface roughness and the haze value of a transparent conductive film formed on a transparent substrate, and capable of sufficiently reducing the surface electric resistance value, regardless of the application method, and to provide a transparent conductive substrate formed using this composition.

### DESCRIPTION OF THE INVENTION

In the present invention, a film obtained immediately after a composition for forming a transparent conductive film containing transparent conductive particles, a binder resin, and a solvent is applied onto a transparent substrate is referred to as “transparent conductive coating film”, a film obtained by evaporating and drying the solvent of the transparent conductive coating film is referred to as a “transparent conductive film”, and an object including a transparent substrate and the transparent conductive film is referred to as a “transparent conductive substrate”. Also, the composition for forming a transparent conductive film is simply referred to as “composition” in some cases.

Composition for Forming Transparent Conductive Film

The above-described composition for forming a transparent conductive film can be prepared by dispersing transparent conductive particles and a binder resin in a solvent. The composition for forming a transparent conductive film has a solid concentration of 20 to 50 mass %. The solid concentration is preferably in a range of 25 to 45 mass %, and more preferably in a range of 30 to 40 mass %.

If the solid concentration of the composition for a transparent conductive film is less than 20 mass %, the solvent amount is high in the composition for forming a transparent conductive film, and thus even if a solvent A and a solvent B that will be described later are used, a large amount of solvent evaporates from the transparent conductive coating film and dries out, the solvent A (a solvent having a relative evaporation rate of 1 or more where the evaporation rate of butyl acetate is 1) being relatively likely to evaporate, and the solvent B (a solvent having relative evaporation rate of less than 1 where the evaporation rate of butyl acetate is 1) being relatively unlikely to evaporate, and thus the filling properties of transparent conductive particles deteriorate due to the influence of a convection flow of the composition caused by evaporation of the solvents, and contact between transparent conductive particles decreases, and thus there is the risk that the surface electric resistance value cannot be sufficiently reduced. Also, there is the risk that the surface roughness will increase or the residual solvent amount in the transparent conductive film will increase.

If the solid concentration exceeds 50 mass %, the composition for forming a transparent conductive film does not disperse sufficiently because the solvent amount is too small, and the dispersion stability decreases, and thus the composition storage stability decreases. Also, there is the risk that a leveling failure will occur.

With a composition for forming a transparent conductive film having a solid concentration of 20 to 50 mass %, in other words, with the composition for forming a transparent conductive film of the present invention containing a solvent in an amount of 50 to 80 mass %, use of a solvent obtained by mixing a solvent A and a solvent B that have different evaporation rates as solvents makes it possible to reduce a residual solvent amount in the transparent conductive film due to the solvent A, which is relatively likely to evaporate, when a transparent conductive film is formed by applying the composition for forming a transparent conductive film to a transparent substrate, and drying the composition. Also, as a result of the solvent B that is relatively unlikely to evaporate undergoing gradual evaporation compared to the solvent A that tends to evaporate, uniform accumulation of transparent conductive particles and uniform filling with transparent conductive particles sufficiently progress until the transparent conductive coating film is dried and solidified, that is, the filling properties are improved, and the surface electric resistance value of the transparent conductive film can be sufficiently reduced due to an increase in contact between transparent conductive particles.

If the above-described solvent A that is relatively likely to evaporate and the above-described solvent B that is relatively unlikely to evaporate are mixed together, the mass ratio between the solvent A and the solvent B is in a range of solvent A:solvent B=40:60 to 5:95. By setting the mass ratio to the above-described range, as with a spray coater application method and a spin coater application method, the solid concentration of the composition tends to increase, and with an application method with which the amount of time to drying and solidification is small, it is possible to make the evaporation rate of the solvent more stable, suppress a rapid increase in the solid concentration more than that of a composition produced with a conventional technique, and ensure a longer period of time to drying and solidification. As a result, it is possible to improve leveling properties and spreadability of the composition, reduce the surface roughness and the haze value of the transparent conductive film, make uniform accumulation of transparent conductive particles and filling with the transparent conductive particles sufficiently progress, that is, improve the filling properties, and realize a transparent conductive film with a low surface electric resistance value. Also, the residual solvent amount in the transparent conductive film can be made less than or equal to that of a composition produced with a conventional technique.

If the ratio of the solvent A, which is relatively likely to evaporate, in all of the mixed solvent is less than 5 parts by mass, the wettability of the solvent against conductive particles decreases, and there is the risk that it will be difficult to maintain a dispersion stability. Also, there is the risk that the drying of the transparent conductive coating film immediately after the composition is applied will become extremely slow, and the residual solvent amount in the transparent conductive coating film will increase. Also, if the ratio of the solvent A, which is relatively likely to evaporate, in all of the mixed solvent exceeds 40 parts by mass, the composition contains an excessive amount of the solvent A that is relatively likely to evaporate, and thus, as with a spray coater application method or a spin coater application method, the solid concentration of the composition tends to increase, and with an application method with which the amount of time to drying and solidification is small, there is the risk that the surface roughness and the haze value will increase due to a failure in spreading of the composition or a failure in leveling of the composition caused by an increase in the solid concentration, or the surface electric resistance value will increase due to a failure in filling with conductive particles resulting from the amount of time to drying and solidification being small. It is preferable that the ratio of the solvent A in all of the mixed solvent is in a range of 10 to 30 parts by mass.

The above-described solvent A and the above-described solvent B each contain at least a ketone-based solvent. Herein, it is preferable that the solvent A contains a ketone-based solvent in an amount of 90 mass % with respect to the total amount of the solvent A. By setting the amount of ketone-based solvent in the above-described range, the dispersiveness of the composition increases, and a composition for forming a transparent conductive film with excellent storage stability can be produced. If the above-described solvent A contains a ketone-based solvent in an amount of less than 90 mass % with respect to the total amount of the solvent A, there is the risk that the dispersiveness of the composition will decrease, and the composition storage stability will decrease. It is more preferable that the solvent A contains a ketone-based solvent in an amount of 95 mass % or more with respect to the total amount of the solvent A.

Also, it is preferable that the above-described solvent B contains a ketone-based solvent in an amount of 70 mass % or more with respect to the total amount of the solvent A. By setting the amount of ketone-based solvent in the above-described range, the dispersiveness of the composition increases, the evaporation rate of the solvent while the composition is applied is stable, and a rapid increase in the solid concentration can be suppressed, and thus the leveling properties and the spreadability of the composition are improved, and the surface roughness and the haze value of a transparent conductive substrate can be reduced. Also, it is possible to ensure a longer period of time to drying and solidification, uniform accumulation of the transparent conductive particles and uniform filling with transparent conductive particles sufficiently progress, that is, the filling properties are improved, and a transparent conductive substrate having a low surface electric resistance value can be obtained. If the above-described solvent B contains a ketone-based solvent in an amount of less than 70 mass % with respect to the total amount of the solvent B, there is the risk that the dispersiveness of the composition will decrease, and the composition storage stability will decrease. It is more preferable that the solvent B contains a ketone-based solvent in an amount of 80 mass % or more with respect to the total amount of the solvent B.

If the above-described solvent A contains a ketone-based solvent in an amount of 90 mass % or more with respect to the total amount of the solvent A, and the above-described solvent B contains a ketone-based solvent in an amount of 70 mass % or more with respect to the total amount of the solvent B, then the solvent A and the solvent B may contain a solvent other than the ketone-based solvents.

Solvent

The solvent A having a relative evaporation rate of 1 or more where the evaporation rate of butyl acetate is 1 and the solvent B having a relative evaporation rate, which was described above, of less than 1 are used as the above-described solvents. Herein, the “relative evaporation rate” refers to a relative evaporation rate where an evaporation rate of butyl acetate is 1, and the larger the value is, the more likely the solvent is to evaporate, and the smaller the value is, the less likely the solvent is to evaporate.

The above-described solvent A and the above-described solvent B each contain at least a ketone-based solvent.

Acetone, methyl ethyl ketone (MEK), methyl isobutyl ketone (MIBK), and the like can be used as ketone-based solvents that are classified into the above-described solvent A having a relative evaporation rate, which was described above, of 1 or more. Also, cyclopentanone, cyclohexanone, cycloheptanone, diisobutyl ketone (DIBK), 2-heptanone, methyl isoamyl ketone, methyl-n-propyl ketone, isophorone, and the like can be used as ketone-based solvents that are classified into the above-described solvent B having a relative evaporation rate, which was described above, of less than 1.

In addition to the above-described ketone-based solvents, alcohol-based solvents, ester-based solvents, aliphatic solvents, aromatic solvents, glycol-based solvents, ether-based solvents, or glycol ether-based solvents may be mixed into the above-described solvents A and B as long as the above-described solvent A has a relative evaporation rate of 1 or more where the evaporation rate of butyl acetate is 1 and the above-described solvent B has a relative evaporation rate of less than 1 where the evaporation rate of butyl acetate is 1. If these solvents are mixed with ketone-based solvents and the resulting solvent is used, it is desirable to add these solvents to an extent that the dispersiveness of conductive microparticles is not impaired.

Examples of solvents other than the above-described ketone-based solvents that are classified into the solvent A include methyl alcohol, ethyl alcohol, isopropyl alcohol, ethyl acetate, isopropyl acetate, normal propyl acetate, tetrahydrofuran, hexane, heptane, cyclohexane, and toluene. Also, examples of solvents other than the above-described ketone-based solvents that are classified into the solvent B include normal propanol, normal butanol, ethyl lactate, ethylene glycol monomethyl ether, diethylene glycol monomethyl ether, ethylene glycol monomethyl ether acetate, diethylene glycol monomethyl ether acetate, ethylene glycol monobutyl ether, diethylene glycol monobutyl ether, ethylene glycol monobutyl ether acetate, diethylene glycol monobutyl ether acetate, propylene glycol monomethyl ether, propylene glycol monomethyl ether acetate, 1,4-dioxane, and xylene.

Transparent Conductive Particles

There is no particular limitation on the above-described transparent conductive particles as long as particles both have transparency and conductivity, and conductive metal oxide particles and conductive nitride particles can be used, for example. Examples of the above-described conductive metal oxide particles include particles of metal oxide such as indium oxide, tin oxide, zinc oxide, and cadmium oxide. Also, conductive metal oxide particles that contain, as a main component, one or more metal oxides selected from the group consisting of indium oxide, tin oxide, zinc oxide, and cadmium oxide and that are doped with tin, antimony, aluminum, or gallium, for example, tin-containing indium oxide (ITO) particles, antimony-containing tin oxide (ATO) particles, aluminum-containing zinc oxide (AZO) particles, gallium-containing zinc oxide (GZO) particles, and conductive metal oxide particles obtained by substituting ITO with aluminum can also be used. From the viewpoint of excellent transparency and conductivity, ITO particles are particularly preferable among these particles. Also, from the viewpoint of conductivity, it is preferable that in the above-described ITO particles, the amount of tin added is in a range of 1 to 20 mass % with respect to the entire amount of ITO in terms of tin oxide. Although the conductivity is improved by adding tin to ITO, if the amount of tin added is less than 1 mass %, there is a tendency for improvement in the conductivity to be poor, and if the amount of tin added exceeds 20 mass %, the conductivity improvement effect tends to be small.

It is preferable that the above-described transparent conductive particles have an average primary particle diameter of 10 to 200 nm. It seems that if the average primary particle diameter is less than 10 nm, it is difficult to perform dispersion treatment and particles tend to aggregate, and cloudiness (haze) increases and such particles tend to have poor optical characteristics. Also, if the average primary particle diameter exceeds 200 nm, it seems that cloudiness (haze) tends to increase due to scattering of visible light caused by particles Herein, the “average primary particle diameter” refers to an “average particle diameter” obtained by observing and measuring the particle diameters of individual particles using an electron microscope and averaging the particle diameters of at least 100 particles, on the surface or a cross-sectional surface of a transparent conductive film formed on a transparent substrate, for example.

Binder Resin

It is preferable that the content of the above-described binder resin included in the composition for forming a transparent conductive film is in a range of 5 to 18 parts by mass with respect to 100 parts by mass of the transparent conductive particles. If the content of the above-described binder resin is less than 5 parts by mass, the coating film strength improvement effect tends to be poor, and if the content of the binder resin exceeds 18 parts by mass, the surface electric resistance value tends to increase, and there is the risk that good conductivity will not be obtained.

Although there is no particular limitation on the above-described binder resin, a resin having a glass transition temperature of 30 to 120° C. is preferable. Use of a resin having a glass transition temperature of 30 to 120° C. as the above-described binder resin provides a transparent conductive film with appropriate flexibility. A thermoplastic resin having a glass transition temperature of 30 to 120° C. or a radiation curable resin having a glass transition temperature of 30 to 120° C. can be used as the above-described binder resin, for example. The above-described binder resin may be used alone or in combination of two or more. Herein, the glass transition temperature can be measured using a DSC method through so-called thermal analysis in conformity with Japanese Industrial Standard (JIS) K7121.

An acrylic resin or a polyester resin can be used as a thermoplastic resin having a glass transition temperature of 30 to 120° C., for example.

Examples of the above-described acrylic resin include “Dianal BR-60”, “Dianal BR-64”, “Dianal BR-75”, “Dianal BR-77”, “Dianal BR-80”, “Dianal BR-83”, “Dianal BR-87”, “Dianal BR-90”, “Dianal BR-95”, “Dianal BR-96”, “Dianal BR-100”, “Dianal BR-101”, “Dianal BR-105”, “Dianal BR-106”, “Dianal BR-107”, “Dianal BR-108”, “Dianal BR-110”, “Dianal BR-113”, “Dianal BR-122”, “Dianal BR-605”, “Dianal MB-2539”, “Dianal MB-2389”, “Dianal MB-2487”, “Dianal MB-2660”, “Dianal MB-2952”, “Dianal MB-3015”, and “Dianal MB-7033”, which are manufactured by MITSUBISHI RAYON CO., LTD.

Examples of the above-described polyester resin include “VYLON 200”, “VYLON 220”, “VYLON 226”, “VYLON 240”, “VYLON 245”, “VYLON 270”, “VYLON 280”, “VYLON 290”, “VYLON 296”, “VYLON 660”, “VYLON 885”, “VYLON GK110”, “VYLON GK250”, “VYLON GK360”, “VYLON GK640”, and “VYLON GK880”, which are manufactured by TOYOBO CO., LTD.

Although there is no particular limitation on the radiation curable resin having a glass transition temperature of 30 to 120° C., examples thereof include acrylate monomers, methacrylate monomers, epoxy acrylates, urethane acrylates, polyester acrylates, and acrylic oligomers. Specifically, isobornyl acrylate, 2-phenoxyethyl methacrylate, tripropylene glycol diacrylate, diethylene glycol diacrylate, ethoxylated bisphenol A dimethacrylate, trimethylolpropane triacrylate, dipentaerythritol pentaacrylate, and the like can be used. Herein, it is preferable to use a measurement value, as the glass transition temperature of a radiation curable resin, which is obtained after radiation curing treatment by adding 5 parts by mass of a UV polymerization initiator, for example, 2-methyl-1-[4-(methylthio)phenyl]-2-morpholinopropane-1-one, to 100 parts by mass of the resin, and emitting UV at 500 mJ/cm².

If a radiation curable resin is used as the binder resin, hardening treatment may be performed with radial rays such as ultraviolet rays, electron rays, or β-rays. From among these rays, it is convenient to use ultraviolet rays, and in this case, a UV polymerization initiator may be added to the radiation curable resin. The initiators below can be used as the above-described UV polymerization initiator. For example, benzoin isopropyl ether, benzophenone, 2-hydroxy-2-methyl propiophenone, 1-hydroxycyclohexyl phenyl ketone, 2,4-diethyl thioxanthone, methyl o-benzoylbenzoate, 4,4-bisdiethylaminobenzophenone, 2,2-diethoxyacetophene, benzyl, 2-chlorothioxanthone, diisopropylthioxanthone, 9,10-anthraquinone, benzoin, benzoin methyl ether, 2,2-dimethoxy-2-phenylacetophenone, 2-hydroxy-2-methyl-propiophenone, 4-isopropyl-2-hydroxy-2-methylpropiophenone, α, α-dimethoxy-α-phenylacetone, and the like can be used. The above-described UV polymerization initiator may be used alone or in combination of two or more.

It is preferable to add the UV polymerization initiator in an amount of 1 to 20 parts by mass to 100 parts by mass of the radiation curable resin. If the amount of the UV polymerization initiator added is less than 1 part by mass, it seems that the resin has inferior curability, and the transparent conductive film has inferior strength. Also, if the amount of the UV polymerization initiator added exceeds 20 parts by mass, it seems that crosslinking does not sufficiently progress, and the transparent conductive film has inferior strength.

Also, a thermosetting resin such as an epoxy resin may be used as a resin having a glass transition temperature of 30 to 120° C.

Other Additives

The above-describe composition for forming a transparent conductive film may contain a dispersing agent, a plasticizer, an antistatic agent, and the like, in addition to the transparent conductive particles and the binder resin.

A dispersing agent including at least an anionic functional group is preferably used as the above-described dispersing agent, and a polyester resin including an anionic functional group, or an acrylic resin including an anionic functional group is more preferably used. For example, it is possible to use a carboxylic acid-containing acrylic resin, an acid-containing polyester resin, acid and base-containing polyester resin, and the like. Specifically, commercially available resins such as “Dianal MR-2539”, “Dianal MB-2389”, “Dianal MB-2660”, “Dianal MB-3015”, “Dianal BR-84”, and the like that are manufactured by MITSUBISHI RAYON CO., LTD., “Solsperse 3000”, “Solsperse 21000”, “Solsperse 26000”, “Solsperse 32000”, “Solsperse 36000”, “Solsperse 41000”, “Solsperse 43000”, “Solsperse 44000”, “Solsperse 45000”, and “Solsperse 56000” that are manufactured by Avecia can be used.

There is no particular limitation on a method for preparing the composition for forming a transparent conductive film as long as transparent conductive particles and a binder resin can be dispersed in the solvent, and there is no particular limitation on their dispersion methods. For example, dispersion treatment using a bead mill such as a sand grind mill, an ultrasonic disperser, a three-roll mill, or the like can be used, and from the viewpoint of excellent dispersiveness, dispersion treatment using a bead mill is preferable.

Transparent Conductive Substrate

The above-described transparent conductive substrate includes a transparent substrate and a transparent conductive film disposed on the transparent substrate, and the transparent conductive film is made of the composition for forming a transparent conductive film. The transparent conductive substrate preferably has a total light transmittance of 75% or more, and more preferably has a total light transmittance of 85% or more. Also, the haze value is preferably 2% or less, and is more preferably 1% or less. By setting the total light transmittance and the haze value of the transparent conductive substrate in the above-described ranges, the transparent conductive substrate can be suitably used as a touch panel, an electrode for a light control film, a transparent surface heating element, an antistatic film of a display, a transparent conductive substrate for an electromagnetic wave shielding member, and the like, for example.

Transparent Substrate

There is no particular limitation on the transparent substrate as long as a substrate is made of a transparent material having translucency. For example, a film or a substrate can be used which is made of a material such as a polyester resin (e.g., polyethylene terephthalate and polyethylene naphthalate); polyolefins; a cellulose resin (e.g., cellulose triacetate); an amide-based resin (e.g., nylon and aramid); a polyether-based resin (e.g., polyphenylene ether and polysulfone ether); a polycarbonate resin; a polyamide resin; a polyimide resin; a polyamide-imide resin; an aromatic polyamide resin; or the like. Also, the transparent substrate may be formed using glass, a ceramic, or the like. In this case, inorganic glass or organic glass (polymer base material) can be used as a glass material. The thickness of the transparent substrate is preferably in a range of 3 to 300 μm, and more preferably in a range of 25 to 200 μm in case of being a film or a substrate. If the composition for forming a transparent conductive film is applied using a spray method or a spin method, the transparent substrate is preferably made of glass or a ceramic.

Also, “transparent” in the present invention refers to the total light transmittance measured in conformity with JIS K7161: 1997 being 75% or more.

Additives such as an antioxidant, a flame retardant, an ultraviolet absorbing agent, a lubricant, and an antistatic agent may be added to the transparent substrate. Furthermore, in order to improve adherence to the transparent conductive film formed on the transparent substrate, the substrate surface can be provided with an easily adhering layer (for example, a primer layer), or a surface treatment such as corona treatment or plasma treatment can be performed.

There is no particular limitation on the method for applying a composition for forming a transparent conductive film to the transparent substrate so as to form a transparent conductive substrate, as long as the application method forms a flat smooth coating film. An application method such as a gravure roll method, a micro gravure roll method, a spray method, a spin method, a knife method, a kiss method, a squeeze method, a reverse roll method, a dipping method, or a bar coating method can be used, for example. In particular, as with a spray coater application method or a spin coater application method, the solid concentration of the composition tends to increase, and thus the composition of the present invention is preferably used in an application method with which the amount of time to drying and solidification is small.

As a method for drying the coating film, hot air may be applied from the transparent conductive coating film side or the transparent substrate side. Also, a heat source may be in direct contact with the transparent substrate. Also, a transparent conductive coating film may be dried using a method without contacting with the heat source, using an infrared heater, a far infrared heater, or the like. Furthermore, the transparent conductive coating film may be naturally dried in a space in which the temperature and humidity are managed.

### WORKING EXAMPLES

Hereinafter, the present invention will be described based on working examples in detail. However, the present invention is not limited to the working examples below. Also, unless otherwise stated, “parts” means “parts by mass” below.

### Working Example 1

### Preparation of Composition A for Forming Transparent Conductive Film

First, a dispersion solution was prepared by subjecting a mixture having the composition below to dispersion treatment using zirconia beads having a diameter of 0.1 mm as the dispersion media, and using a paint conditioner as a disperser.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing components below was added to 100 parts or less of the dispersion solution obtained above, and was stirred for 30 minutes, the resulting mixture was then passed through a filter (glass fiber filter “AP-25” manufactured by Japan Millipore), and a “composition A for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 71.1 parts

### Working Example 2

Preparation of Composition B for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition B for forming a transparent conductive film” was obtained.

(5) Binder resin (acrylic resin, “Dianal BR-83” manufactured by MITSUBISHI RAYON CO., LTD.): 1.9 parts

(6) Solvent A (methyl ethyl ketone): 10.0 parts

(7) Solvent B (cyclohexanone): 61.1 parts

### Working Example 3

Preparation of Composition C for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition C for forming a transparent conductive film” was obtained.

(5) Binder resin (acrylic resin, “Dianal BR-83” manufactured by MITSUBISHI RAYON CO., LTD.): 1.9 parts

(6) Solvent A (toluene: non-ketone-based solvent): 11.1 parts

(7) Solvent B (cyclohexanone): 60.0 parts

### Working Example 4

Preparation of Composition D for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition D for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 40 parts

(7) Solvent B (propylene glycol monomethyl ether: non-ketone-based solvent): 31.1 parts

### Working Example 5

Preparation of Composition E for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 6 parts

(4) Solvent B (cyclohexanone): 44 parts

Next, a mixture containing the components below was added to 100 parts of the dispersion solution obtained above, and similarly to Working Example 1, a “composition E for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 67.1 parts

### Working Example 6

Preparation of Composition F for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition F for forming a transparent conductive film” was obtained.

(5) Binder resin (acrylic resin, “Dianal BR-83” manufactured by MITSUBISHI RAYON CO., LTD.): 1.9 parts

(6) Solvent A (methyl ethyl ketone): 23.0 parts

(7) Solvent B (cyclohexanone): 48.1 parts

### Working Example 7

Preparation of Composition G for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition G for forming a transparent conductive film” was obtained.

(5) Binder resin (acrylic resin, “Dianal BR-83” manufactured by MITSUBISHI RAYON CO., LTD.): 1.9 parts

(6) Solvent A (methyl ethyl ketone): 39.0 parts

(7) Solvent B (cyclohexanone): 110.0 parts

### Working Example 8

Preparation of Composition H for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 20 parts

(4) Solvent B (cyclohexanone): 30 parts

Next, a mixture containing the components below was added to 100 parts of the dispersion solution obtained above, and similarly to Working Example 1, a “composition H for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 4.0 parts

### Comparative Example 1

Preparation of Composition I for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl ethyl ketone): 25 parts

(4) Solvent B (cyclohexanone): 25 parts

Next, a mixture containing the components below was added to 100 parts of the dispersion solution obtained above, and similarly to Working Example 1, a “composition I for forming a transparent conductive film” was obtained.

(5) Binder resin (acrylic resin, “Dianal BR-83” manufactured by MITSUBISHI RAYON CO., LTD.): 1.9 parts

(6) Solvent A (methyl isobutyl ketone): 51.1 parts

(7) Solvent B (cyclohexanone): 20.0 parts

### Comparative Example 2

Preparation of Composition J for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition J for forming a transparent conductive film” was obtained.

(5) Binder resin (acrylic resin, “Dianal BR-83” manufactured by MITSUBISHI RAYON CO., LTD.): 1.9 parts

(6) Solvent A (methyl isobutyl ketone): 61.1 parts

(7) Solvent B (cyclohexanone): 10.0 parts

### Comparative Example 3

Preparation of Composition K for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 5 parts

(4) Solvent B (cyclohexanone): 45 parts

Next, a mixture containing the components below was added to 100 parts of the dispersion solution obtained above, and similarly to Working Example 1, a “composition K for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 71.1 parts

### Comparative Example 4

Preparation of Composition L for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (propylene glycol monomethyl ether acetate: non-ketone-based solvent): 25 parts

Next, a mixture containing the components below was added to 100 parts of the dispersion solution obtained above, and similarly to Working Example 1, a “composition L for forming a transparent conductive film” was obtained.

(5) Binder resin (acrylic resin, “Dianal BR-83” manufactured by MITSUBISHI RAYON CO., LTD.): 1.9 parts

(6) Solvent B (propylene glycol monomethyl ether acetate: non-ketone-based solvent): 71.1 parts

### Comparative Example 5

Preparation of Composition M for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 15 parts

(4) Solvent B (cyclohexanone): 25 parts

Next, a mixture containing the components below was added to 90 parts of the dispersion solution obtained above, and similarly to Working Example 1, a “composition M for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 2.5 parts

### Comparative Example 6

Preparation of Composition N for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (methyl isobutyl ketone): 25 parts

(4) Solvent B (cyclohexanone): 25 parts

Next, a mixture containing the components below was added to 100 parts of the dispersion solution obtained above, and similarly to Working Example 1, a “composition N for forming a transparent conductive film” was obtained.

(5) Binder resin (acrylic resin, “Dianal BR-83” manufactured by MITSUBISHI RAYON CO., LTD.): 1.9 parts

(6) Solvent A (methyl isobutyl ketone): 71.1 parts

(7) Solvent B (cyclohexanone): 173 parts

### Comparative Example 7

Preparation of Composition O for Forming Transparent Conductive Film

First, a dispersion solution was prepared similarly to Working Example 1, using a mixture having the composition below.

(1) ITO particles (average primary particle diameter was 20 nm, tin oxide content was 8 mass %): 45 parts

(2) Binder resin (acrylic resin, “Dianal BR-113” manufactured by MITSUBISHI RAYON CO., LTD.): 5 parts

(3) Solvent A (ethyl acetate: non-ketone-based solvent): 25 parts

(4) Solvent B (cyclohexanone): 25 parts

Next, a mixture containing the components below was added to 100 parts of the dispersion solution obtained above, and similarly to Working Example 1, a “composition O for forming a transparent conductive film” was obtained.

(5) Binder resin (acrylic resin, “Dianal BR-83” manufactured by MITSUBISHI RAYON CO., LTD.): 1.9 parts

(6) Solvent B (cyclohexanone): 71.1 parts

Production of Transparent Conductive Substrate

Transparent conductive substrates were produced using the compositions A to H for forming a transparent conductive film of Working Examples 1 to 8 and the compositions I to O for forming a transparent conductive film of Comparative Examples 1 to 7.

The compositions A to O for forming a transparent conductive film were applied to rectangular transparent glass substrates (alkali-free glass “Eagle XG” manufactured by Corning, thickness was 0.7 mm) using a spin coater whose rotation rate was adjusted such that the thickness of the dried film was 0.7 μm, the substrates were dried in an environment at 25° C. for 1 minute after the compositions were applied thereto, then dried in a constant temperature room at 80° C. for 3 minutes, and transparent conductive substrates of Working Examples 1 to 8 and Comparative Examples 1 to 7 were obtained. At this time, the distance from a composition discharge port of the spin coater to the transparent glass substrate was 5.0 mm.

The compositions A to O for forming a transparent conductive film were applied to rectangular transparent glass substrates (alkali-free glass “Eagle XG” manufactured by Corning, thickness was 0.7 mm) using a bar coater whose count was adjusted such that the thickness of the dried film was 0.7 μm, the substrates were dried in an environment at 25° C. for 1 minute after the compositions were applied thereto, then dried in a constant temperature room at 80° C. for 3 minutes, and transparent conductive substrates of Working Examples 1 to 8 and Comparative Examples 1 to 7 were obtained.

Subsequently, the following characteristics were evaluated using the transparent conductive substrates.

Initial Surface Electric Resistance Value

The composition for forming a transparent conductive film was produced, applied to a transparent glass substrate in 24 hours or less, and dried so as to form a transparent conductive substrate in which the transparent conductive film was formed on the transparent glass substrate, and the transparent conductive substrate was used as a measurement sample. An initial surface electric resistance value of the transparent conductive film was measured using a resistivity meter (“Loresta MCP-T610” manufactured by Mitsubishi ChemicalAnalytec Co., Ltd.). Specifically, an average value of surface electric resistance values at four locations between central points on each side of the transparent conductive film and a central point of the transparent conductive film was regarded as a measurement value of the initial surface electric resistance value. A case where the initial surface electric resistance value was less than 10,000 Ω/sq was evaluated as “good”, a case where the initial surface electric resistance value was 10,000 to 15,000 Ω/sq was evaluated as “fair”, and a case where the initial surface electric resistance value exceeded 15,000 Ω/sq was evaluated as “poor”.

Surface Roughness

The composition for forming a transparent conductive film was produced, applied to a transparent glass substrate in 24 hours or less, and dried so as to form a transparent conductive substrate in which the transparent conductive film was formed on the transparent glass substrate, and the obtained transparent conductive substrate was used as a measurement sample. The surface roughness of the transparent conductive film was evaluated by measuring an arithmetic average roughness (Ra) under observation at a 100-fold magnification, using a three-dimensional surface structure analysis microscope (“NewView5030” manufactured by ZYGO). A case where Ra was less than 5.0 nm was evaluated as “good”, a case where Ra was in a range of 5.0 to 8.0 nm was evaluated as “fair”, and a case where Ra exceeded 8.0 nm was evaluated as “poor”. The lower the Ra is, the more superior the smoothness of the surface is.

Haze Value

The composition for forming a transparent conductive film was produced, applied to a transparent glass substrate in 24 hours or less, and dried so as to form a transparent conductive substrate in which the transparent conductive film was formed on the transparent glass substrate, and the obtained transparent conductive substrate was used as a measurement sample. The haze value was measured using a method (mode: method 1) conforming with JIS K7361, using a haze meter (“NDH2000” manufactured by NIPPON DENSHOKU INDUSTRIES CO., LTD.”), and the haze value of the entire transparent conductive substrate including a transparent glass substrate was evaluated. A case where the haze value was less than 1.0% was evaluated as “good”, a case where the haze value was in a range of 1.0 to 2.0% was evaluated as “fair”, and a case where the haze value exceeded 2.0% was evaluated as “poor”. The lower the haze value is, the more superior the optical characteristics are.

Composition Storage Stability

The storage stability was evaluated as follows using the compositions A to H for forming a transparent conductive film of Working Examples 1 to 8 and the compositions I to O for forming a transparent conductive film of Comparative Examples 1 to 7.

The composition for forming a transparent conductive film was produced, stored in an environment at 25° C. for 7 days, applied to a rectangular transparent glass substrate (alkali-free glass “Eagle XG” manufactured by Corning, the thickness was 0.7 mm) using a spin coater, and dried to produce a transparent conductive substrate in which a transparent conductive film having a thickness of 0.7 μm was formed on the transparent glass substrate, and the transparent conductive substrate was used as a measurement sample.

Surface electric resistance values at four locations between central points on each side of the transparent conductive film and a central point of the transparent conductive film were measured using a resistivity meter (“Loresta MCP-T610” manufactured by Mitsubishi Chemical Analytec Co., Ltd.). An average value of the surface electric resistance values at the four locations was regarded as a measurement value of the surface electric resistance value after storage. A case where the rate of change that was calculated using the surface electric resistance value after storage and the previous measured initial surface electric resistance value was 5% or less was evaluated as the storage stability of the composition for forming a transparent conductive film being “good”, a case where the rate of change was greater than or equal to 6% and less than 10% was evaluated as the storage stability thereof being “fair”, and a case where the rate of change was 10% or more was evaluated as the storage stability thereof being “poor”.

Rate of change (%)=[(surface electric resistance value after storage−initial surface electric resistance value)/initial surface electric resistance value]×100

The composition of each of the compositions A to O for forming a transparent conductive film that were produced in Working Examples 1 to 8 and Comparative Examples 1 to 7 is shown in Tables 1 to 4. Also, the above-described evaluation results are shown in Tables 5 to 8.

TABLE 1

| | | Working Example 1 | Working Example 2 | Working Example 3 | Working Example 4 |
|---|---|---|---|---|---|
| Composition for forming | | A | B | C | D |
| transparent conductive film | | | | | |
| Dispersion | ITO particles | 45 | 45 | 45 | 45 |
| solution | (parts) | | | | |
| | Binder resin | 5 | 5 | 5 | 5 |
| | (parts) | | | | |
| | Solvent A | 25 (methyl | 25 (methyl | 25 (methyl | 25 (methyl |
| | (parts) | isobutyl ketone) | isobutyl ketone) | isobutyl ketone) | isobutyl ketone) |
| | Solvent B | 25 | 25 | 25 | 25 |
| | (parts) | (cyclohexanone) | (cyclohexanone) | (cyclohexanone) | (cyclohexanone) |
| Mixed | Dispersion | 100 | 100 | 100 | 100 |
| components | solution | | | | |
| | (parts) | | | | |
| | Binder resin | 1.9 | 1.9 | 1.9 | 1.9 |
| | (parts) | | | | |
| | Solvent A | 0 | 10.0 (methyl ethyl | 11.1 (toluene) | 0 |
| | (parts) | | ketone) | | |
| | Solvent B | 71.1 | 61.1 | 60.0 | 40.0 |
| | (parts) | (cyclohexanone) | (cyclohexanone) | (cyclohexanone) | (cyclohexanone) |
| | | | | | 31.1 (propylene |
| | | | | | glycol |
| | | | | | monomethyl |
| | | | | | ether) |
| Final | Solvent A | 21 | 29 | 30 | 21 |
| composition | (parts) | | | | |
| | Ketone-based | 100 | 100 | 69 | 100 |
| | solvent in | | | | |
| | solvent A | | | | |
| | (mass %) | | | | |
| | Solvent B | 79 | 71 | 70 | 79 |
| | (parts) | | | | |
| | Ketone-based | 100 | 100 | 100 | 68 |
| | solvent in | | | | |
| | solvent B | | | | |
| | (mass %) | | | | |
| | Solid | 30 | 30 | 30 | 30 |
| | concentration | | | | |
| | (mass %) | | | | |

TABLE 2

| | | Working Example 5 | Working Example 6 | Working Example 7 | Working Example 8 |
|---|---|---|---|---|---|
| Composition for forming | | E | F | G | H |
| transparent conductive film | | | | | |
| Dispersion | ITO particles | 45 | 45 | 45 | 45 |
| solution | (parts) | | | | |
| | Binder resin | 5 | 5 | 5 | 5 |
| | (parts) | | | | |
| | Solvent A | 6 (methyl isobutyl | 25 (methyl | 25 (methyl | 20 (methyl |
| | (parts) | ketone) | isobutyl ketone) | isobutyl ketone) | isobutyl ketone) |
| | Solvent B | 44 | 25 | 25 | 30 |
| | (parts) | (cyclohexanone) | (cyclohexanone) | (cyclohexanone) | (cyclohexanone) |
| Mixed | Dispersion | 100 | 100 | 100 | 100 |
| components | solution | | | | |
| | (parts) | | | | |
| | Binder resin | 1.9 | 1.9 | 1.9 | 1.9 |
| | (parts) | | | | |
| | Solvent A | 0 | 23.0 (methyl ethyl | 39.0 (methyl ethyl | 0 |
| | (parts) | | ketone) | ketone) | |
| | Solvent B | 67.1 | 48.1 | 110.0 | 4.0 |
| | (parts) | (cyclohexanone) | (cyclohexanone) | (cyclohexanone) | (cyclohexanone) |
| Final | Solvent A | 5 | 40 | 32 | 37 |
| composition | (parts) | | | | |
| | Ketone-based | 100 | 100 | 100 | 100 |
| | solvent in | | | | |
| | solvent A | | | | |
| | (mass %) | | | | |
| | Solvent B | 95 | 60 | 68 | 63 |
| | (parts) | | | | |
| | Ketone-based | 100 | 100 | 100 | 100 |
| | solvent in | | | | |
| | Solvent B | | | | |
| | (mass %) | | | | |
| | Solid | 31 | 30 | 21 | 49 |
| | concentration | | | | |
| | (mass %) | | | | |

TABLE 3

| | | Comparative | Comparative | Comparative | Comparative |
|---|---|---|---|---|---|
| | | Example 1 | Example 2 | Example 3 | Example 4 |
| Composition for forming | | I | J | K | L |
| transparent conductive film | | | | | |
| Dispersion | ITO particles | 45 | 45 | 45 | 45 |
| solution | (parts) | | | | |
| | Binder resin | 5 | 5 | 5 | 5 |
| | (parts) | | | | |
| | Solvent A | 25 (methyl ethyl | 25 (methyl | 5 (methyl | 25 (methyl |
| | (parts) | ketone) | isobutyl ketone) | isobutyl ketone) | isobutyl ketone) |
| | Solvent B | 25 | 25 | 45 | 25 (propylene |
| | (parts) | (cyclohexanone) | (cyclohexanone) | (cyclohexanone) | glycol |
| | | | | | monomethyl |
| | | | | | ether acetate) |
| Mixed | Dispersion | 100 | 100 | 100 | 100 |
| components | solution | | | | |
| | (parts) | | | | |
| | Binder resin | 1.9 | 1.9 | 1.9 | 1.9 |
| | (parts) | | | | |
| | Solvent A | 51.1 (methyl | 61.1 (methyl | 0 | 0 |
| | (parts) | isobutyl ketone) | isobutyl ketone) | | |
| | Solvent B | 20.0 | 10.0 | 71.1 | 71.1 (propylene |
| | (parts) | (cyclohexanone) | (cyclohexanone) | (cyclohexanone) | glycol |
| | | | | | monomethyl |
| | | | | | ether acetate) |
| Final | Solvent A | 63 | 71 | 4 | 21 |
| composition | (parts) | | | | |
| | Ketone-based | 100 | 100 | 100 | 100 |
| | solvent in | | | | |
| | solvent A | | | | |
| | (mass %) | | | | |
| | Solvent B | 37 | 29 | 96 | 79 |
| | (parts) | | | | |
| | Ketone-based | 100 | 100 | 100 | 0 |
| | solvent in | | | | |
| | solvent B | | | | |
| | (mass %) | | | | |
| | Solid | 30 | 30 | 30 | 30 |
| | concentration | | | | |
| | (mass %) | | | | |

TABLE 4

| | | Comparative | Comparative | Comparative |
|---|---|---|---|---|
| | | Example 5 | Example 6 | Example 7 |
| Composition for forming | | M | N | O |
| transparent conductive film | | | | |
| Dispersion | ITO particles | 45 | 45 | 45 |
| solution | (parts) | | | |
| | Binder resin | 5 | 5 | 5 |
| | (parts) | | | |
| | Solvent A (parts) | 15 (methyl | 25 (methyl | 25 (ethyl acetate) |
| | | isobutyl ketone) | isobutyl ketone) | |
| | Solvent B (parts) | 25 (cyclohexanone) | 25 (cyclohexanone) | 25 (cyclohexanone) |
| Mixed | Dispersion | 90 | 100 | 100 |
| components | solution (parts) | | | |
| | Binder resin | 1.9 | 1.9 | 1.9 |
| | (parts) | | | |
| | Solvent A (parts) | 0 | 71.1 (methyl | 0 |
| | | | isobutyl ketone) | |
| | Solvent B (parts) | 2.5 | 173 | 71.1 |
| | | (cyclohexanone) | (cyclohexanone) | (cyclohexanone) |
| Final | Solvent A (parts) | 35 | 33 | 21 |
| composition | Ketone-based | 100 | 100 | 0 |
| | solvent in | | | |
| | solvent A | | | |
| | (mass %) | | | |
| | Solvent B (parts) | 65 | 67 | 79 |
| | Ketone-based | 100 | 100 | 100 |
| | solvent in | | | |
| | solvent B | | | |
| | (mass %) | | | |
| | Solid | 55 | 15 | 30 |
| | concentration | | | |
| | (mass %) | | | |

TABLE 5

| | | Working | | Working | | Working | | Working | |
|---|---|---|---|---|---|---|---|---|---|
| | | Example 1 | | Example 2 | | Example 3 | | Example 4 | |
| Composition storage stability: | | 2 | (good) | 3 | (good) | 8 | (fair) | 6 | (fair) |
| rate of change (%) | | | | | | | | | |
| Spin | Thickness of | 0.7 | | 0.7 | | 0.7 | | 0.7 | |
| coater | transparent conductive | | | | | | | | |
| | film (μm) | | | | | | | | |
| | Initial surface electric | 7600 | (good) | 7800 | (good) | 11000 | (fair) | 12000 | (fair) |
| | resistance value (Ω/sq) | | | | | | | | |
| | Surface roughness Ra | 4.0 | (good) | 4.2 | (good) | 4.4 | (good) | 4.8 | (good) |
| | (nm) | | | | | | | | |
| | Haze value (%) | 0.7 | (good) | 0.7 | (good) | 0.8 | (good) | 1.2 | (fair) |
| Bar | Thickness of | 0.7 | | 0.7 | | 0.7 | | 0.7 | |
| coater | transparent conductive | | | | | | | | |
| | film (μm) | | | | | | | | |
| | Initial surface electric | 7600 | (good) | 7700 | (good) | 11200 | (fair) | 11800 | (fair) |
| | resistance value (Ω/sq) | | | | | | | | |
| | Surface roughness Ra | 4.1 | (good) | 4.2 | (good) | 4.5 | (good) | 4.7 | (good) |
| | (nm) | | | | | | | | |
| | Haze value (%) | 0.7 | (good) | 0.8 | (good) | 0.8 | (good) | 1.2 | (fair) |

TABLE 6

| | | Working | | Working | | Working | | Working | |
|---|---|---|---|---|---|---|---|---|---|
| | | Example 5 | | Example 6 | | Example 7 | | Example 8 | |
| Composition storage stability: | | 5 | (good) | 3 | (good) | 3 | (good) | 4 | (good) |
| rate of change (%) | | | | | | | | | |
| Spin | Thickness of | 0.7 | | 0.7 | | 0.7 | | 0.7 | |
| coater | transparent conductive | | | | | | | | |
| | film (μm) | | | | | | | | |
| | Initial surface electric | 8500 | (good) | 7800 | (good) | 9400 | (good) | 9000 | (good) |
| | resistance value (Ω/sq) | | | | | | | | |
| | Surface roughness Ra | 4.8 | (good) | 4.3 | (good) | 4.6 | (good) | 4.7 | (good) |
| | (nm) | | | | | | | | |
| | Haze value (%) | 0.9 | (good) | 0.7 | (good) | 0.9 | (good) | 0.8 | (good) |
| Bar | Thickness of | 0.7 | | 0.7 | | 0.7 | | 0.7 | |
| coater | transparent conductive | | | | | | | | |
| | film (μm) | | | | | | | | |
| | Initial surface electric | 8700 | (good) | 7700 | (good) | 8900 | (good) | 9200 | (good) |
| | resistance value (Ω/sq) | | | | | | | | |
| | Surface roughness Ra | 4.8 | (good) | 4.2 | (good) | 4.5 | (good) | 4.6 | (good) |
| | (nm) | | | | | | | | |
| | Haze value (%) | 0.8 | (good) | 0.7 | (good) | 0.8 | (good) | 0.8 | (good) |

TABLE 7

| | | Comparative | | Comparative | | Comparative | | Comparative | |
|---|---|---|---|---|---|---|---|---|---|
| | | Example 1 | | Example 2 | | Example 3 | | Example 4 | |
| Composition storage stability: | | 2 | (good) | 2 | (good) | 7 | (fair) | 20 | (poor) |
| rate of change (%) | | | | | | | | | |
| Spin | Thickness of | 0.7 | | 0.7 | | 0.7 | | 0.7 | |
| coater | transparent | | | | | | | | |
| | conductive film (μm) | | | | | | | | |
| | Initial surface electric | 13500 | (fair) | 15500 | (poor) | 17200 | (poor) | 23000 | (poor) |
| | resistance value | | | | | | | | |
| | (Ω/sq) | | | | | | | | |
| | Surface roughness Ra | 8.5 | (poor) | 9.6 | (poor) | 7.3 | (fair) | 11.5 | (poor) |
| | (nm) | | | | | | | | |
| | Haze value (%) | 1.2 | (fair) | 2.3 | (poor) | 1.7 | (fair) | 2.8 | (poor) |
| Bar | Thickness of | 0.7 | | 0.7 | | 0.7 | | 0.7 | |
| coater | transparent | | | | | | | | |
| | conductive film (μm) | | | | | | | | |
| | Initial surface electric | 9000 | (good) | 9500 | (good) | 17500 | (poor) | 22500 | (poor) |
| | resistance value | | | | | | | | |
| | (Ω/sq) | | | | | | | | |
| | Surface roughness Ra | 4.6 | (good) | 4.8 | (good) | 7.8 | (fair) | 11.0 | (poor) |
| | (nm) | | | | | | | | |
| | Haze value (%) | 0.9 | (good) | 0.9 | (good) | 1.8 | (fair) | 2.6 | (poor) |

TABLE 8

| | | Comparative | | Comparative | | Comparative | |
|---|---|---|---|---|---|---|---|
| | | Example 5 | | Example 6 | | Example 7 | |
| Composition storage stability: | | 8 | (fair) | 3 | (good) | 12 | (poor) |
| rate of change (%) | | | | | | | |
| Spin | Thickness of | 0.7 | | 0.7 | | 0.7 | |
| coater | transparent conductive | | | | | | |
| | film (μm) | | | | | | |
| | Initial surface electric | 16200 | (poor) | 15200 | (poor) | 21000 | (poor) |
| | resistance value (Ω/sq) | | | | | | |
| | Surface roughness Ra | 8.8 | (poor) | 7.1 | (fair) | 8.8 | (poor) |
| | (nm) | | | | | | |
| | Haze value (%) | 2.3 | (pool) | 2.3 | (poor) | 2.1 | (poor) |
| Bar | Thickness of | 0.7 | | 0.7 | | 0.7 | |
| coater | transparent conductive | | | | | | |
| | film (μm) | | | | | | |
| | Initial surface electric | 16300 | (poor) | 9800 | (good) | 21200 | (poor) |
| | resistance value (Ω/sq) | | | | | | |
| | Surface roughness Ra | 8.4 | (poor) | 4.9 | (good) | 8.2 | (poor) |
| | (nm) | | | | | | |
| | Haze value (%) | 2.1 | (poor) | 1.5 | (fair) | 2.1 | (poor) |

With Working Examples 1, 2, and 5 to 8 using the compositions A, B, and E to H for forming a transparent conductive film, the rate of change in the surface electric resistance values before and after the coating materials were stored in an environment at 25° C. for 7 days was 5% or less with respect to the initial surface electric resistance values, and “good” evaluation was obtained. Also, the transparent conductive substrates that were formed using the compositions A, B, and E to H for forming a transparent conductive film were evaluated as “good” in all of the initial surface electric resistance value, the surface roughness, and the haze value in the case of being formed using a spin coater and in a case of being formed using a bar coater.

With Working Example 3 using the composition C for forming a transparent conductive film, the solvent A contained a small amount of a ketone-based solvent, and thus the rate of change in the surface electric resistance value was 8%, and the composition storage stability was evaluated as “fair”. Also, the transparent conductive substrate that was provided with the transparent conductive film using a spin coater had an initial surface electric resistance value of 11,000 Ω/sq, and the transparent conductive substrate that was provided with the transparent conductive film using a bar coater had an initial surface electric resistance value of 11,200 Ω/sq, and were evaluated as “fair”.

With Working Example 4 using the composition D for forming a transparent conductive film, the solvent B contained a small amount of a ketone-based solvent, and thus the rate of change in the surface electric resistance value was 6%, and the composition storage stability was evaluated as “fair”. Also, the transparent conductive substrate that was provided with the transparent conductive film using a spin coater had an initial surface electric resistance value of 12,000 Ω/sq, and the transparent conductive substrate that was provided with the transparent conductive film using a bar coater had an initial surface electric resistance value of 11,800 Ω/sq, and were evaluated as “fair”. Also, the haze values of the transparent conductive substrates were both 1.2%, and were evaluated as “fair”.

In contrast, with Comparative Example 1 using the composition I for forming a transparent conductive film, the transparent conductive substrate that was provided with the transparent conductive film using a spin coater contained a large amount of solvent A having a relative evaporation rate of 1 or more, the solvent quickly dried from the composition, and the transparent conductive substrate had an initial surface electric resistance value of 13,500 Ω/sq and had a haze value of 1.2%, and was evaluated as “fair”. Also, the surface roughness was 8.5 nm and evaluated as “poor”.

With Comparative Example 2 using the composition J for forming a transparent conductive film, the transparent conductive substrate that was provided with the transparent conductive film using a spin coater contained the solvent A having a relative evaporation rate of 1 or more in a larger amount than in Comparative Example 1, and the solvent dried from the composition more quickly than in Comparative Example 1, and thus the initial surface electric resistance value was 15,500 Ω/sq and evaluated as “poor”, the surface roughness was 9.6 nm and evaluated as “poor”, and the haze value was 2.3% and evaluated as “poor”.

With Comparative Example 3 using the composition K for forming a transparent conductive film, the amount of the solvent B having a relative evaporation rate of 1 or less was too large, and thus the rate of change in the surface electric resistance value was 7%, and the composition storage stability was evaluated as “fair”. Also, the transparent conductive substrate that was provided with the transparent conductive film using a spin coater had an initial surface electric resistance value of 17,200 Ω/sq, and the transparent conductive substrate that was provided with the transparent conductive film using a bar coater had an initial surface electric resistance value of 17,500 Ω/sq, and initial surface electric resistance values were evaluated as “poor”, the surface roughnesses were respectively 7.3 nm and 7.8 nm and evaluated as “fair”, and the haze values were respectively 1.7% and 1.8% and evaluated as “fair”.

With Comparative Example 4 using the composition L for forming a transparent conductive film, the ketone-based solvent in the solvent B was 0, and thus the rate of change in the surface electric resistance value was 20%, and the composition storage stability was evaluated as “poor”. Also, the transparent conductive substrate that was provided with the transparent conductive film using a spin coater application method had an initial electric resistance value of 23,000 Ω/sq, and the transparent conductive substrate that was provided with the transparent conductive film using a bar coater application method had an initial electric resistance value of 22,500 Ω/sq, the surface roughnesses were respectively 11.5 nm and 11.0 nm, and the haze values were respectively 2.8% and 2.6%, which were all evaluated as “poor”.

With Comparative Example 5 using the composition M for forming a transparent conductive film, the solid concentration of the composition was high and the viscosity increased, and sufficient dispersion was not achieved, the rate of change in the surface electric resistance value was 8%, and the composition storage stability was evaluated as “fair”. Also, the transparent conductive substrate that was provided with the transparent conductive film using a spin coater application method had an initial electric resistance value of 16,200 Ω/sq, and the transparent conductive substrate that was provided with the transparent conductive film using a bar coater application method had an initial electric resistance value of 16,300 Ω/sq, the surface roughnesses were respectively 8.8 nm and 8.4 nm, and the haze values were respectively 2.3% and 2.1%, which were all evaluated as “poor”.

With Comparative Example 6 using the composition N for forming a transparent conductive film, the transparent conductive substrate that was provided with the transparent conductive film using a spin coater had a low solid concentration of the composition, and thus the drying time increased in coating film formation, and the transparent conductive substrate had an initial surface electric resistance value of 15,200 Ω/sq and a haze value of 2.3%, which were evaluated as “poor”. Also, the surface roughness was 7.1 nm and evaluated as “fair”. Also, the transparent conductive substrate that was provided with the transparent conductive film using a bar coater application method had a haze value of 1.5% and was evaluated as “fair”.

With Comparative Example 7 using the composition O for forming a transparent conductive film, the ketone-based solvent in the solvent A was 0, and thus the rate of change in the surface electric resistance value was 12%, and the composition storage stability was evaluated as “poor”. Also, the transparent conductive substrate that was provided with the transparent conductive film using a spin coater application method had an initial electric resistance value of 21,000 Ω/sq, and the transparent conductive substrate that was provided with the transparent conductive film using a bar coater application method had an initial electric resistance value of 21,200 Ω/sq, the surface roughnesses were respectively 8.8 nm and 8.2 nm, and the haze values were respectively 2.1% and 2.1%, which were all evaluated as “poor”.

The present invention may be embodied in other forms without departing from the spirit thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A composition for forming a transparent conductive film, the composition comprising:
transparent conductive particles;
a binder resin; and
a solvent,
wherein the composition for forming a transparent conductive film has a solid concentration of 20 to 50 mass %,
the solvent includes a solvent A having a relative evaporation rate of 1 or more and a solvent B having a relative evaporation rate of less than 1, where an evaporation rate of butyl acetate is 1,
a mass ratio between the solvent A and the solvent B is solvent A:solvent B=40:60 to 5:95, and
the solvent A and the solvent B each contain at least a ketone-based solvent.

2. The composition for forming a transparent conductive film according to claim 1,
wherein the solvent A contains the ketone-based solvent in an amount of 90 mass % or more with respect to the total amount of the solvent A, and
the solvent B contains the ketone-based solvent in an amount of 70 mass % or more with respect to the total amount of the solvent B.

3. The composition for forming a transparent conductive film according to claim 1,
wherein the ketone-based solvent having a relative evaporation rate of 1 or more is at least one selected from the group consisting of acetone, methyl ethyl ketone, and methyl isobutyl ketone.

4. The composition for forming a transparent conductive film according to claim 1,
wherein the ketone-based solvent having a relative evaporation rate of less than 1 is at least one selected from the group consisting of cyclopentanone, cyclohexanone, cycloheptanone, diisobutyl ketone, 2-heptanone, methyl isoamyl ketone, methyl-n-propyl ketone, and isophorone.

5. A transparent conductive substrate comprising:
a transparent substrate; and
a transparent conductive film disposed on the transparent substrate,
wherein the transparent conductive film is formed using the composition for forming a transparent conductive film according to claim 1.

6. The transparent conductive substrate according to claim 5,
wherein the transparent conductive substrate has a total light transmittance of 75% or more.

7. The transparent conductive substrate according to claim 5,
wherein the transparent conductive substrate has a haze value of 2% or less.
